(19) United States
(12) Patent Application Publication
(10) Pub. No.: US 2021/0140474 A1
(43) Pub. Date: May 13, 2021

(54) MONOTECTIC ALUMINUM PLAIN BEARING ALLOY, METHOD FOR PRODUCING SAME, AND PLAIN BEARING PRODUCED THEREWITH

(71) Applicant: ZOLLERN BHW GLEITLAGER GMBH & CO.KG, Braunschweig (DE)

(72) Inventors: Edgar GUST, Wolfenbüttel (DE); Kostyantyn GZOVSKYY, Braunschweig (DE)

(21) Appl. No.: 16/622,623

(22) PCT Filed: May 24, 2018
(86) PCT No.: PCT/DE2018/100501

§ 371 Date: Dec. 13, 2019

(30) Foreign Application Priority Data
Jun. 15, 2017 (DE) 10 2017 113 216.3

(51) Int. Cl. F16C 33/12; C22C 21/10; C22C 21/14; C22C 21/18; C22F 1/057; C22F 1/053; F16C 17/02

(52) U.S. Cl. CPC F16C 33/122; C22C 21/10; C22C 21/14; F16C 2204/20; C22F 1/057; C22F 1/053; F16C 17/02; C22C 21/18

(57) ABSTRACT

The invention relates to a monotectic aluminum plain bearing alloy having bismuth inclusions, which alloy is suitable for plastic deformation and consists of 1 to 20 wt % bismuth, at least one element selected from 0.05 to 7 wt % copper, 0.05 to 15 wt % silicon, 0.05 to 3 wt % manganese, 0.05 to 5 wt % zinc as a primary alloying element and, in combination, 0.005 to 0.4 wt % titanium, 0.005 to 0.7 wt % zirconium, 0.001 to 0.1 wt % boron as additional alloying elements, and optionally one or more further additional elements, the remainder aluminum. The plain bearing alloy is ultra-fine-grained and has superplastic-like properties.

The invention relates to a monotectic aluminum plain bearing alloy having bismuth inclusions which is suitable for plastic deformation.

The invention further relates to a process for producing a monotectic aluminum plain bearing alloy having bismuth inclusions.

The invention further relates to a plain bearing produced using the plain bearing alloy.

Highly stressed plain bearings are made up of a plurality of layers in order to satisfy the variety of requirements which the bearing has to meet and which are sometimes contrary to one another. Steel-aluminum composite materials are frequently used.

While the steel support shell ensures absorption of the mechanical stress and provides firm seating, the plain bearing materials have to withstand the variety of tribological stresses and be fatigue-resistant. In order to meet this requirement, the plain bearing materials contain hard phases such as silicon and intermetallic precipitates and also soft phases such as lead or tin in the aluminum matrix. Highly stressable multilayer plain bearings frequently additionally have a sliding layer applied by electroplating to the functional layer. This soft sliding layer ensures the good emergency operation properties of the bearing. It can embed abraded particles and thus remove them from the sliding surface.

An environmentally friendly alternative to lead-containing aluminum plain bearing alloys is provided by plain bearings based on aluminum-tin, which are used without additional sliding layer. However, the mechanical properties of these alloys, for example the fatigue resistance and hot strength, are subject to limitations. The comparatively high tin content leads to formation of a contiguous tin network at the grain boundaries during casting, and this considerably impairs the strength of these alloys, especially at relatively high temperatures.

Compared to tin, bismuth has some advantages as soft phase in the aluminum matrix. Thus, bismuth has a higher melting point and can be used at higher temperatures. In addition, it is possible to avoid strong enrichment of bismuth at the grain boundaries of the plain bearing alloys by means of specific casting and heat treatment measures and obtain a sufficiently uniform and fine distribution of the bismuth droplets in the microstructure, which ultimately leads to an improvement in the strength of the alloy and the tribological properties compared to aluminum-tin alloys.

It has thus been proposed in DE 4003018 A1 that an aluminum alloy can contain one or more of the components: from 1 to 50% by weight, preferably from 5 to 30% by weight, of lead, from 3 to 50% by weight, preferably from 5 to 30% by weight, of bismuth and from 15 to 50% by weight of indium and additionally one or more of the components: from 0.1 to 20% by weight of silicon, from 0.1 to 20% by weight of tin, from 0.1 to 10% by weight of zinc, from 0.1 to 5% by weight of magnesium, from 0.1 to 5% by weight of copper, from 0.05 to 3% by weight of iron, from 0.05 to 3% by weight of manganese, from 0.05 to 3% by weight of nickel and from 0.001 to 0.30% by weight of titanium. This alloy known from DE 4003018 A1 is cast vertically by continuous casting to give a strip or wire having a thickness or diameter of from 5 to 20 mm, with the melt being cast with a cooling rate of from 300 to 1500 K/s. The fast cooling rate is intended to prevent large-volume precipitates of a minority phase from being formed during the time between the temperature going below the demixing temperature and complete solidification of the matrix metal. However, it is known from practical experience of continuous casting of aluminum alloys that very high cooling rates result in a considerable risk of crack formation and in the processability required for mass production being difficult to ensure.

The process described in EP 0 940 474 A1 makes it possible for a monotectic aluminum plain bearing alloy which comprises up to 15% by weight of bismuth together with at least one element from the group consisting of silicon, tin, lead in a total amount of from 0.5 to 15% by weight and also possible additions from the group consisting of copper, manganese, magnesium, nickel, chromium, zinc and antimony in a total amount of up to 3% and is difficult to manage in foundry technology terms to be cast in reproducible quality by continuous casting. Homogeneous distribution of the minority phase is in this case achieved by intensive stirring of the melt in an electromagnetic field. In addition, the microstructure of this alloy is refined by addition of grain refining agents. This also has, inter alia, an advantageous effect on the size of the droplet-shaped bismuth precipitates which in the cast state have a diameter of not more than 40 μm. The amount of grain refining agents added is, according to EP 0 940 474 A1, calculated by means of a formula which takes into account the bismuth content in the melt. This invention does not give any information as to the type of grain refining additives used in order to lead to the results described in the patent.

An alloy comprising from 4 to 7% by weight of bismuth, from 1 to 4.5% by weight of silicon, from 0 to 1.7% by weight of copper, from 0 to 2.5% by weight of lead and at least one element from the group consisting of nickel, manganese, chromium in a total amount of up to 1% and additionally at least one element from the group consisting of tin, zinc, antimony in a total amount of up to 5% by weight is known from EP 0 190 691 A1. Although high proportions of silicon strengthen the aluminum matrix, they have an adverse effect on the size of the minority phase and lead to a significant deterioration in the droplet distribution in the cast alloy. During rolling of such a cast microstructure, the originally spherical lead or bismuth phase is deformed to give very thick threads which considerably decrease the mechanical strength and the tribological properties of the material.

One possible solution for setting the desired materials properties is reshaping of the longitudinally stretched precipitates of the minority phase to give compact microstructural shapes by means of a subsequent heat treatment. For example, according to DE 4014430 A1 a monotectic-aluminum-silicon-bismuth alloy is heat treated at temperatures of from 575° C. to 585° C. in order to achieve a fine distribution of the bismuth phase which has been stretched into a platelet shape after rolling.

As a further advantage, the heat treatment offers the opportunity of improving the strength values of the aluminum plain bearing alloy by means of hardening effects. The elements suitable for achieving the possible hardening effects are, for example, silicon, magnesium, zinc and zirconium. The addition of copper increases the hardening rate and can be used in combination with these elements. An aluminum plain bearing alloy having a bismuth content of from 2 to 15% by weight, from 0.05 to 1% by weight of zirconium and also a copper content and/or magnesium content up to 1.5% is known from U.S. Pat. No. 5,286,445. In addition, this alloy contains at least one element from the group consisting of tin, lead and indium in a total amount of from 0.05 to 2% by weight or at least one element from the group consisting of silicon, manganese, vanadium, antimony, niobium, molybdenum, cobalt, iron, titanium, chromium in a total amount of from 0.05 to 5% by weight. The additions of tin, lead and indium assist the recoagulation of stretched bismuth droplets to give finer precipitates at temperatures of from 200° C. to 350° C. The elements zirconium, silicon and magnesium bring about the actual hardening effect after heat treatment in the temperature range from 480° C. to 525° C., which according to U.S. Pat. No. 5,286,445 is carried out shortly before the roll cladding operation. The transition elements are set to bring about an additional increase in the mechanical strength of the material.

The unfavorable effect of silicon on the size and distribution of the minority phase has been mentioned above. The addition of magnesium has the additional disadvantage that magnesium preferentially forms the intermetallic compound Mg₃Bi₂ with bismuth. This is incorporated into the bismuth droplets and significantly decreases the ability of abraded particles to be embedded in the bismuth droplets. Addition of tin considerably impairs the mechanical strength of the plain bearing material at relatively high temperatures. In addition, the temperatures of the heat treatment of above 480° C. as proposed in DE 4014430 A1 and in U.S. Pat. No. 5,286,445 lead to formation of brittle intermetallic phases between the steel support shell and the aluminum.

The above-described bismuth-containing alloys have hitherto not all attained practical importance since the complex events occurring in production of the alloys by continuous casting and subsequent further processing to give the plain bearing shell have up to now not been controlled to a sufficient extent. A prerequisite for an optimum property profile of the aluminum plain bearing alloys is, in addition to a fine distribution of the minority phase in the cast state, in particular the possibility of being able to retain a fine distribution of the minority phase even after the required forming and roll cladding operations. Further requirements are a high strength, ability to withstand mechanical stresses, even at, inter alia, high temperatures, wear resistance of the aluminum matrix and also good formability.

It is therefore an object of the invention to form, by means of an appropriate combination of the alloy elements, an alloy which is characterized by a specific ultra-fine-grained microstructure having small bismuth inclusions and makes it possible to achieve a uniform and fine distribution of the bismuth phase and retain this during subsequent further processing of the strips, for example in the manufacturing phase to produce a plain bearing shell.

This object is achieved by a monotectic aluminum plain bearing alloy having bismuth inclusions which consists of from 1 to 20% by weight of bismuth, at least one element selected from among from 0.05 to 7% by weight of copper, from 0.05 to 15% by weight of silicon, from 0.05 to 3% by weight of manganese and from 0.05 to 5% by weight of zinc as main alloying elements and from 0.005 to 0.4% by weight of titanium, from 0.005 to 0.7% by weight of zirconium and from 0.001 to 0.1% by weight of boron as additional elements and also optionally one or more further additional elements, balance aluminum.

The aluminum plain bearing alloy of the invention is ultra-fine-grained and has a uniform and fine distribution of the bismuth phase. It has improved technological properties such as rollability, weldability with steel and long-term strength of the plain bearing metal. These properties are achieved by the special nature of the interaction of aluminum with manganese, silicon, zinc and/or copper and with the combination of titanium, zirconium and boron in the liquid state and in the process of crystallization. The combination of the additional elements titanium, zirconium and boron surprisingly brings about the ultra-fine-grained structure which is also retained during subsequent after-processing. The combination of the abovementioned additional alloying elements leads to formation of a specific ultra-fine-grained microstructure of from about 100 to 20 μm with small bismuth inclusions of from 50 to 1 μm in an aluminum-bismuth-manganese (copper, silicon or zinc) alloy. This microstructure is suitable for high-degree plastic forming. After such forming, the alloy of the invention displays a behavior which resembles superplastic behavior and ensures improved mechanical and tribological properties, namely good fatigue behavior, a low seizing limit, a low relative wear and a high specific load-bearing capability. The combination of titanium, zirconium and boron brings about grain refinement of aluminum alloys containing copper, zinc, silicon or manganese or a combination of these elements as main alloying elements. The plain bearing alloy of the invention has superplastic properties. Superplastic properties of aluminum alloys are known in principle.

Alloys having superplastic formability are known from T. Ruspaev, U. Draugelates and B. Bouaifi; Einflus der Al₂Cu—Phase auf die Superplastizität der AlCuMn Legierung, Mat-wiss. u. Werkstofftech. 34, 219-224, 2003. Examples given are: AlZn5.7Mg1.6Zr0.4; AlZn6.1Mg3.1Cu1.5MnCrTi; AlCu6Zr0.5; AlCu6Mn0.4Zr0.2.

It is known from U.S. Pat. No. 3,841,919 A that alloy compositions in the delimited concentration range: point A (89.8% of Al, 9.7% of Si and 0.5% of Mg), point B (78.6% of Al, 14.1% of Si and 7.3% of Mg), point C (78.5% of Al, 16.6% of Si and 4.9% of Mg) and point D (86.3% of Al, 13.2% of Si and 0.5% of Mg) display superplasticity.

It is known from EP 0 297 035 B1 that alloys comprising 0.8-2.5% of Si, 3.5-6.0% of Mg, 0.1-0.6% of Mn, 0.05-0.5% of Zr, max. 6.0% of Zn, max. 3.0% Cu, 0.3% of Si, 0.05% of Ti, 0.05% of Cr, balance aluminum, are suitable for superplastic formability.

WO/1983/001629 discloses a superplastic aluminum alloy plate containing from 1.5 to 9.0% of magnesium, from 0.5 to 5.0% of silicon, from 0.05 to 1.2% of manganese, from 0.05 to 0.3% of chromium and a balance of aluminum and a process for producing a superplastic aluminum alloy plate by continuous casting of a molten aluminum alloy containing from 1.5 to 9.0% of magnesium, from 0.5 to 5.0% of silicon, from 0.05 to 1.2% of manganese and from 0.05 to 0.3% of chromium in order to form a strip having a thickness of from 3 to 20 mm, with the strip being subjected to homogenization. Processing is carried out at from 430 to 550° C. and cold rolling to a rolling ratio of 60% or more.

It is known from the postdoctoral thesis for attainment of authorization to teach in the subject of materials technology by Dr.-Ing. Dipl.-Phys. Ralph Jörg Hellmig, TU Clausthal, 2008 “Hoch-gradige plastische Umformung durch Equal Channel Angular Pressing (ECAP)” that alloys having superplastic formability are characterized by specific, ultra-fine-grained nitrostructures and have the following properties:
a significant increase in strength compared to conventional materials
adjustable states of high strength and ductility as a result of a suitable combination with heat treatments
extreme superplasticity
improved fatigue behavior.

It is known that metallurgical causes of superplasticity are:
grain boundary sliding (grain shape is retained) (model: oily sand), rotation and translocation of the individual grains)
dislocation creep (obstacles such as vacancies or interstitial atoms are overcome by thermally activated processes)
diffusion creep (vacancies diffuse through the crystal lattice)
dynamic recovery process (recovery event such as transverse sliding of screw dislocations).

The present invention is based on the recognition that the combination of the additional elements titanium, zirconium and boron leads to an ultra-fine-grained, superplastic-like monotectic aluminum plain bearing alloy having small bismuth inclusions, which is suitable for high-degree plastic forming. However, an increase in the element concentrations above 7% by weight in the case of copper or zinc, above 15% by weight in the case of silicon and above 3% by weight in the case of manganese leads to a coarsening of the structure and a deterioration in the alloy properties. The content of zinc is preferably up to 2.5% by weight, more preferably in the range from 0.5 to 2% by weight. The content of silicon is preferably in the range from 1.2 to 15% by weight, with proportions of from 1.5 to 5% by weight and from 10 to 15% by weight being particularly preferred.

An explanation of the ultra-fine-grained structure of the plain bearing alloy of the invention is the formation of specific clusters having a high packing density.

Manganese has an only insignificantly smaller atomic radius (Mn_{atomic radius}=127 μm) than aluminum (Al_{atomic radius}=143 μm). The ratio of the atomic radii is Mn_{atomic radius}/−Al_{atomic radius}=0.8881 [D.B. Miracle, Candidate Atomic Cluster Configurations in Metallic Glass Structures. Materials Transactions, Vol. 47, No. 7 (2006) pp. 1737 to 1742].

This is very close to the optimum ratio of the atomic radii of 0.9 for the formation of icosahedral clusters having the coordination number 12.

Silicon has an only insignificantly smaller atomic radius (Si_{atomic radius}=110 μm) than aluminum (Al_{atomic radius}=143 μm). The ratio of the atomic radii is Si_{atomic radius}/−Al_{atomic radius}=0.769 [D.B. Miracle, Candidate Atomic Cluster Configurations in Metallic Glass Structures. Materials Transactions, Vol. 47, No. 7 (2006) pp. 1737 to 1742].

Copper and zinc likewise have an only insignificantly smaller atomic radius (Cu(Zn)_{atomic radius}=135 μm) than aluminum (Al_{atomic radius}=143 μm). The ratio of the atomic radii is Cu(Zn)_{atomic radius}/Al_{atomic radius}=0.94 [D.B. Miracle, Candidate Atomic Cluster Configurations in Metallic Glass Structures. Materials Transactions, Vol. 47, No. 7 (2006) pp. 1737 to 1742].

This is very close to the optimum ratio of the atomic radii of 0.9 for the formation of icosahedral clusters having the coordination number 12.

Titanium has an only insignificantly smaller atomic radius (Ti_{atomic radius}=140 μm) than aluminum (Al_{atomic radius}=143 μm). The ratio of the atomic radii is Ti_{atomic radius}/−Al_{atomic radius}=0.979 [D.B. Miracle, Candidate Atomic Cluster Configurations in Metallic Glass Structures. Materials Transactions, Vol. 47, No. 7 (2006) pp. 1737 to 1742].

This is very close to the optimum ratio of the atomic radii of 1.0 for the formation of octahedral, FCC (face-centered) or cuboctahedral clusters having the coordination number 12.

Zirconium has an only insignificantly greater atomic radius (Zr_{atomic radius}=155 μm) than aluminum (Al_{atomic radius}=143 μm). The ratio of the atomic radii is Ti_{atomic radius}/−Al_{atomic radius}=1.08 [D.B. Miracle, Candidate Atomic Cluster Configurations in Metallic Glass Structures. Materials Transactions, Vol. 47, No. 7 (2006) pp. 1737 to 1742].

Boron has a significantly smaller atomic radius (B_{atomic radius}=85 μm) than aluminum (Al_{atomic radius}=143 μm). The ratio of the atomic radii is Ti_{atomic radius}/Al_{atomic radius}=0.594 [D.B. Miracle, Candidate Atomic Cluster Configurations in Metallic Glass Structures. Materials Transactions, Vol. 47, No. 7 (2006) pp. 1737 to 1742].

This is very close to the optimum ratio of the atomic radii of 0.591 for the formation of icosahedral clusters having the coordination number 7.

Boron in combination with titanium and/or aluminum plays an important role in the formation of the structure of the alloy during crystallization.

It is known that icosahedral or decahedral clusters, in particular with the coordination number 7, have a particular tendency to a high degree of subcooling of the melt. In the subcooled state, icosahedral or decahedral short-range order arises and clusters having a high packing density are formed. Icosahedral short-range order and the solid body have significantly different packing. The increase in the packing density in the event of strong subcooling inhibits diffusion of the atoms for crystallization and for other phase transformations. In the case of a high degree of subcooling, the melt has a large excess of free energy which the system can utilize for a variety of solidification routes far outside equilibrium in various metastable phases. Thus, metastable solids which can consist of supersaturated mixed phases, grain-refined alloys, disordered superlattice structures, metastable crystallographic phases can be formed. This leads to considerable strengthening of the alloy.

Based on these calculations, manganese, copper and zinc, zirconium and titanium lead to formation of particularly dense and stable clusters with aluminum having the coordination number 12, the configuration of which can be decahedral, icosahedral or octahedral, FCC (face-centered) or cuboctahedral. This leads to a particularly effective interaction between aluminum and copper and zinc, zirconium, titanium and manganese atoms, with copper and zinc, zirconium, titanium and manganese being initiators for dense packing both in the liquid state and the solid state.

The decahedral or icosahedral packing and the solid body have significantly different packing. The increase in the packing density in the case of a high degree of subcooling inhibits diffusion of the atoms for crystallization and for other phase transformations. In the case of great subcooling, the melt has a large excess of free energy which the system can utilize for a variety of solidification routes far outside equilibrium in various metastable phases. Thus, metastable solids which can consist of supersaturated mixed phases, grain-refined alloys, disordered superlattice structures, metastable crystallographic phases can be formed. The grain refinement achieved by cluster formation leads to a change in the morphology of a coarse-grained dendritic microstructure to an equiaxial grain-refined microstructure having a typical grain size of less than 100 microns. This also leads to significant refinement of a bismuth phase down to an average size of 20 microns.

Excessively large amounts of additional alloying elements can increase the crystallization interval and hinder optimum interaction between aluminum and copper, silicon, manganese, zinc, titanium, zirconium, boron. This contributes to development of segregations and to enlarging of the bismuth inclusions, as a result of which the properties of the alloy deteriorate. To ensure the positive influence of copper and zinc, zirconium, titanium and manganese, it is useful for the amount of additional elements to be less than 1.0% by weight.

In the plain bearing alloy of the invention, bismuth serves as sole soft phase former, i.e. there is no combination of bismuth with lead and/or tin present for this purpose. Lead and/or tin should occur in the plain bearing alloy of the invention in at most small amounts with a total proportion of less than 0.5% by weight, if at all.

Further additional alloying elements make it possible to specifically adjust the properties of the alloy of the invention to a particular use.

The eligible additional alloying elements can be divided into five groups:

Group 1:

Tantalum, niobium, hafnium, vanadium, tungsten, molybdenum, antimony, scandium, cerium, calcium in a total proportion of not more than 0.5% by weight.

Group 2:

Nickel, cobalt, iron, chromium in a total proportion of not more than 1% by weight.

Group 3:

Carbon, nitrogen in a total proportion of not more than 0.1% by weight.

Group 4:

Silver, germanium, lithium in a total proportion of not more than 1.0% by weight.

Group 5:

Tin, lead in a total proportion of not more than 0.5% by weight.

In the individual groups, lower limits are in each case 0.001% by weight, i.e. essentially the detection limit.

The additional alloying elements of group 1 display two mechanisms of action. These mechanisms generally act simultaneously, but in some cases one predominates over the other.

Mechanism of Action 1:

The elements tantalum, niobium, hafnium, vanadium, tungsten, molybdenum, antimony, scandium, cerium have a larger or at least not significantly smaller atomic radius than aluminum and lead to formation of particularly dense and stable clusters having the coordination number 12—decahedral or octahedral and cuboctahedral clusters. The decahedral packing and the solid body have significantly different packing. An increase in the packing density in the case of a high degree of subcooling inhibits diffusion of the atoms for crystallization and for other phase transformations. In the case of great subcooling, the melt has a large excess of free energy which the system can utilize for a variety of solidification routes far outside equilibrium in various metastable phases. Thus, metastable solids which can consist of supersaturated mixed phases, grain-refined alloys, disordered superlattice structures, metastable crystallographic phases can be formed. The grain refinement achieved by cluster formation leads to a change in the morphology from a coarse-grain dendritic microstructure to an equiaxial grain-refined microstructure having a typical grain size of less than 100 microns. This also leads to significant refining of the bismuth phase down to an average size of 20 microns. During the formation of octahedral and cuboctahedral clusters, crystal growth predominates. The packings of the octahedral and cuboctahedral clusters and of the solid body have similarities. In this case, only a very small degree of subcooling occurs in front of the solidification front and a trans-crystalline microstructure having a typical grain size of less than 500 microns with small inclusions of bismuth to an average size of 10 microns within the trans-crystalline grains is formed.

Mechanism of Action 2:

The elements tantalum, niobium, hafnium, vanadium, tungsten, molybdenum, scandium react peritectically with aluminum and lead to formation of additional crystal nuclei composed of an AlₓM1 phase, where M1 is one of the abovementioned metals. The additional crystallization nuclei lead to refinement of the matrix (αA1). This also leads to refinement of the bismuth phase down to an average size of 40 microns. The additional crystallization nuclei can be composed of Al₃V, Al₃Nb, Al₃Ta phase. The grain refinement by nucleus formation changes the morphology from a coarse-grain dendritic microstructure to a fine-grain dendritic microstructure having a typical grain size of more than 100 microns. If the second mechanism dominates strongly, which is often the case when a high concentration of additional alloying elements of group 1 forms a coarse intermetallic phase, the bismuth phase is coarsened up to a grain size of 100 microns. Since the increase in the AlₓM1 phase can in this case, too, lead to a decrease in the plasticity and coarsening of the bismuth phase, an upper limit of 0.5% by weight should be imposed on the total proportion.

Sc, Hf, Nb, Zr, Ti, V, Mn form supersaturated a mixed crystals, particularly in the case of high solidification rates. A subsequent heat treatment converts the dissolved Sc, Zr, Ti, V, Mn in a targeted manner into Al₃XYZ, where XYZ is Sc, Hf, Nb, Zr, Ti, V, for example: Al₃(Sc, Zr) or Al₃(Ti, Zr) Al₁₂Mn₂CU nanophases. The high density of these nanostructured phases brings about a significant increase in strength combined with greater toughness. These nanostructured phases inhibit the recrystallization process and lead to formation and retention of ultra-fine-grained grain structures. These ultimately lead to the particular properties of the ultra-fine-grained superplastic-like monotectic aluminum plain bearing alloy having small bismuth inclusions, which is suitable for high-degree plastic forming.

The additional alloying elements of group 2, namely nickel, cobalt, iron, chromium, which have a significantly smaller atomic radius than aluminum, lead to the formation of particularly dense and stable clusters with coordination numbers 12, 11, 10, 9 of the icosahedral cluster type which display a eutectic transformation with aluminum. The additional alloying elements of group 2, namely silicon, zinc, copper, nickel, cobalt, iron, chromium, form the eutectic e(αAl+AlₓM2_{y}) with aluminum, where M2 is one of the elements from this group. The eutectic thus consists of two phases, namely αAl mixed crystal and the intermetallic phase AlₓM2_{y}. Alloying atoms dissolved in the αAl mixed crystals brought about mixed crystal hardening. AlₓM2_{y} particles finely dispersed in the matrix represent obstacles for the migrating dislocations and bring about particle hardening. It is known that eutectic alloys have a particular tendency to a high degree of subcooling. In the subcooled state, an icosahedral close-range order arises and clusters having a high packing density are formed. Icosahedral close-range order and the solid body have significantly different packing. The increase in the packing density in the case of a high degree of subcooling inhibits diffusion of the atoms for crystallization and for other phase transformations. In the case of great subcooling, the melt has a large excess of free energy which the system can utilize for a variety of solidification routes far outside equilibrium in various metastable phases. Thus, metastable solids which can consist of supersaturated mixed phases, grain-refined alloys, disordered superlattice structures, metastable crystallographic phases can be formed. This leads to considerable strengthening of the alloy. Since a high proportion of eutectic can contribute to a lowering of the plasticity, an upper limit of 1.0% by weight should be imposed on the total proportion.

The elements carbon and nitrogen of group 3, or a combination of carbon, nitrogen with titanium, zirconium, tantalum, niobium, vanadium, result in formation of mainly additional crystallization nuclei. These additional crystallization nuclei can be AlTiC, AlTiB, TaC, TiC phase. Since an increase in the abovementioned phases can contribute to lowering of the plasticity, an upper limit of 0.1% by weight is imposed on the total proportion of these alloying elements.

The additional alloying elements of group 4, namely silver, germanium, lithium, are soluble in the aluminum matrix and form αAl mixed crystals. This brings about mixed crystal hardening. The total proportion should be limited to 1.0% by weight.

It has been found that the addition of titanium and boron can also be effected by use of the commercial grain refining agent AlTi5B1 or AlTi3C0.15 in added amounts of from about 0.3 to 2% by weight. This produces a strong grain-refining action on the alloy of the invention and hot cracking in continuous casting using various cooling rates is reliably prevented. The addition of the grain refining agents mentioned also brings about a significant reduction in the size of the minority phase. The maximum diameter of the bismuth droplets has been able to be reduced to less than 30 microns by use of grain refining additives in the cast state, even at relatively low cooling rates of about 5 K/s.

The invention further provides a process for producing an aluminum plain bearing alloy using the composition according to the invention as described above. The alloy constituents are preferably combined to form an alloy in a casting process in which the cooling rate is from 5 to 300 K/s. The cooling rate can be increased up to 1000 K/s when the abovementioned grain refining agents are added. The alloy can otherwise be produced using other conventional production processes, in particular by means of other casting processes. At present, production by continuous casting is preferred. The conditions should be adapted so that preferably droplet-shaped bismuth inclusions are formed. During continuous casting, the offtake velocity is preferably from 2 to 15 mm/s. The alloy obtained by casting is, in a particular embodiment of the present invention, subjected to at least one heat treatment at temperatures in the range from about 230 to 400° C. during the course of subsequent forming processes. Such a heat treatment preferably follows a rolling operation and/or roll cladding operation with a plurality of rolling and/or cladding operations being able to be carried out within the manufacturing process between casting of the alloy and the end product and at least one heat treatment following the last rolling operation and/or roll cladding operation or else a plurality or all of these operations.

To provide a semifinished product or during the course of production of products such as plain bearings, the cast alloy can be provided with at least one support layer. The support layer can be, in particular, a steel layer. Further layers, e.g. bonding promoting layers or coatings, can be added thereto.

The invention further provides a plain bearing shell which contains an alloy according to the invention as one of the materials used therein, or consists of such an alloy. Finally, the invention provides a plain bearing comprising such a plain bearing shell and also the use of the alloy according to the invention in a plain bearing.

The invention will be illustrated below with the aid of a working example.

To produce the plain bearing material, cast strips having a cross section of 10 mm×130 mm are produced on a continuous casting plant in this example. To produce the strips, the offtake speed is 8 mm/s and the cooling rate is 100 K/s. The strips are firstly horizontally milled at the broad sides to a thickness of about 8 mm. A brushed and degreased bonding agent composed of an aluminum alloy is subsequently applied by cladding in the first rolling pass to the likewise brushed and degreased AlBi7Mn1.4Cu0.5Ti0.15Zr0.3B0.005, AlBi7Mn2.3Cu1.6Cr0.35Ti0.15Zr0.15B0.003, AlBi5Cu1.5Mn0.45Ti0.25Zr0.23B0.004, AlBi5Cu2.5Zn2Si1Mn0.45Ti0.25Zr0.25B0.002, or AlSi11Bi7Cu0.5Ti0.17Zr0.22B0.009 alloy in a roll stand.

In order to improve the cladability of the aluminum bearing material strip, the latter is subjected to a recovery heat treatment at 370° C. for up to 3 hours. The thickness of the clad precursor material strip is 4 mm. This is subsequently rolled down to 1.3 mm in only one rolling pass and joined to steel strip on a cladding rolling mill.

Subsequently, the material composite produced is subjected to a heat treatment at a temperature of 360° C. for 3 hours, with the bonding between the steel and the aluminum bearing material being increased by a diffusion process and the bismuth threads which are greatly elongated in the aluminum-zinc-copper matrix after cladding being transformed predominantly into fine spherical droplets having a size of up to 20 μm. The high hardness of at least

55 HB (2.5/62. 5/30) in the case of AlBi7Mn1.4Cu0.5Ti0.15Zr0.3B0.005,
62 HB in the case of AlBi7Mn2.3Cu1.6Cr0.35Ti0.15Zr0.15B0.003,
60 HB in the case of AlBi5Cu1.5Mn0.45Ti0.25Zr0.23B0.004,
63 HB in the case of AlBi5Cu2.5Zn2Si1Mn0.45Ti0.25Zr0.025B0.002, and
82 HB in the case of AlSi11Bi7Cu0.5Ti0.17Zr0.22B0.009 (table 1) which likewise results from the heat treatment is advantageous. After this heat treatment, the clad strip can be cut up and shaped to give bearing shells.

Comparison of the technological and mechanical properties (table 1) of the AlZn5Cu3Bi7 alloy as per WO2006131129A1 and the newly developed alloys AlBi7Mn1.4Cu0.5Ti0.15Zr0.3B0.005 and AlBi7Mn2.3Cu1.6Cr0.35Ti0.15Zr0.15B0.003; AlBi5Cu1.5Mn0.45Ti0.25Zr0.23B0.004; AlBi5Cu2.5Zn2Si1Mn0.45Ti0.25Zr0.23B0.002, AlSi11Bi7Cu0.5Ti0.17Zr0.22B0.009 shows that the newly developed alloys have the better technological and mechanical properties.

TABLE 1
See comparison of the technological and mechanical properties (table 1) of
the AlZn5Cu3Bi7 alloy as per WO2006131129A1 and the newly developed alloys

| | Hardness | Rolling passes |
|---|---|---|
| | 2.5/62.5/30 after | required to |
| | heat treatment for | achieve 1.3 mm |
| Alloy | 3 hours at 360° C. | after cladding |
| AlZn5Cu3Bi7, from WO2006131129A1 | 43 | 5 |
| AlBi7Mn1.4Cu0.5Ti0.15Zr0.3B0.005 | 55 | 1 |
| AlBi7Mn2.3Cu1.6Cr0.35Ti0.15Zr0.15B0.003 | 62 | 1 |
| AlBi5Cu1.5Mn0.45Ti0.25Zr0.23B0.004 | 60 | 1 |
| AlBi5Cu2.5Zn2Si1Mn0.45Ti0.25Zr0.25B0.002 | 63 | 1 |
| AlSi11Bi7Cu0.5Ti0.17Zr0.22B0.009 | 72 | 1 |

The plain bearing alloy of the invention is preferably continuously cast and as early as in the cast state has a fine distribution of the bismuth phase which is largely independent of the offtake speed and cooling rate. Long bismuth plates formed in the course of a further treatment involving rolling and roll cladding can subsequently be completely recoagulated by a heat treatment at temperatures of from 270° C. to 400° C. to give finely distributed spherical droplets which under appropriate process conditions are smaller than 20 μm. The alloy preferably contains from about 7 to 12% by weight of bismuth. The proportion of manganese is in the range from 1 to 5% by weight, in particular from about 1.3 to 4.5% by weight. The proportions of the various elements can be varied independently of one another within the limits indicated.

The attached pictures of the microstructure clarify the structure of working examples.

FIGS. 1 and 2 show the microstructure of AlBi7Mn1.4Cu0.5Ti0.15Zr0.3B0.005 and AlBi7Mn2.3Cu1.6Cr0.35Ti0.15Zr0.15B0.003 alloys after casting and after applying to steel strip by cladding. The bismuth phase appears dark.

FIG. 3 shows the microstructure of the AlBi7Mn1.4Cu0.5Ti0.15Zr0.3B0.005 alloy (etched) clad to steel strip.

FIG. 4 shows the microstructure of the AlSi11Bi7Cu0.5Ti0.17Zr0.22B0.009 alloy (etched).

It should be pointed out that the examples serve solely for the purposes of illustration and do not restrict the invention. A person skilled in the art will also know how plain bearings and bearing shells are produced and how the production of the alloy according to the invention can be incorporated into conventional bearing production processes.

1. A monotectic aluminum plain bearing alloy having bismuth inclusions which is suitable for plastic deformation, comprising:
from 1 to 20% by weight of bismuth,
at least one main alloying element selected from the group consisting of
from 0.05 to 7% by weight of copper,
from 0.05 to 15% by weight of silicon,
from 0.05 to 3% by weight of manganese,
from 0.05 to 5% by weight of zinc,
at least one additional alloying element that acts in combination with at least one main alloying element selected from the consisting of
from 0.005 to 0.4% by weight of titanium,
from 0.005 to 0.7% by weight of zirconium,
from 0.001 to 0.1% by weight of boron,
optionally one or more further additional elements, and
a balance of aluminum.

2. The plain bearing alloy as claimed in claim 1,
wherein the one or more further additional elements are present and are selected from the following groups:
group 1:
tantalum, niobium, hafnium, vanadium, tungsten, molybdenum, antimony, scandium, cerium, calcium in a total proportion of not more than 0.5% by weight;
group 2:
nickel, cobalt, iron, chromium in a total proportion of not more than 1% by weight;
group 3:
carbon, nitrogen in a total proportion of not more than 0.1% by weight;
group 4:
silver, germanium, lithium in a total proportion of not more than 1.0% by weight;
group 5:
tin, lead in a total proportion of not more than 0.5% by weight.

3. The plain bearing alloy as claimed in claim 1 wherein a proportion of bismuth in the plain bearing alloy is from 4.5 to 15.5% by weight.

4. The plain bearing alloy as claimed in claim 1 wherein the at least one main alloying element is manganese and/or copper and/or silicon and/or zinc in a proportion from 0.5 to 2.8% by weight.

5. The plain bearing alloy as claimed in claim 1 further comprising up to 3% by weight of Al—Ti—B or Al—Ti—C grain refining agent.

6. A process for producing an aluminum plain bearing alloy having the composition as claimed in claim 1 wherein the bismuth, aluminium, and main and additional alloying elements are combined to give the aluminium plain bearing alloy in a casting process in which a cooling rate is in a range from 5 to 300 K/s.

7. The process as claimed in claim 6, wherein the casting process is a continuous casting process.

8. The process as claimed in claim 6 wherein the aluminium plain bearing alloy is provided with at least one support layer to provide a semifinished part.

9. The process as claimed in claim 6 further comprising subjecting the aluminium plain bearing alloy to at least one heat treatment at temperatures of from 200° C. to 400° C. during subsequent forming processes.

10. The process as claimed in claim 9, wherein the at least one heat treatment is carried out in a rolling operation and/or roll cladding operation.

11. A plain bearing element comprising a support layer and a plain bearing alloy as claimed in claim 1 applied to the support layer.

12. A plain bearing formed with at least one plain bearing element as claimed in claim 11.

13. The plain bearing alloy as claimed in claim 1 wherein a proportion of bismuth in the plain bearing alloy is from 5 to 8% by weight.

14. The plain bearing alloy as claimed in claim 4 wherein the at least one main alloying element is manganese and/or copper and/or silicon and/or zing in a proportion from 0.7 to 1.5% by weight.
